(19) United States
(12) Patent Application Publication
(10) Pub. No.: US 2026/0046888 A1
(43) Pub. Date: Feb. 12, 2026

(54) ENHANCING CONTROL MESSAGES FOR NON-ORTHOGONAL MULTIPLE ACCESS SCHEMES

(71) Applicant: Lenovo (Singapore) Pte Limited, Singapore (SG)

(72) Inventors: Robin Rajan THOMAS, Bad Nauheim (DE); Ali Ramadan Ali, Kraiburg am Inn (DE)

(21) Appl. No.: 18/797,349

(22) Filed: Aug. 7, 2024

(51) Int. Cl. H04W 72/231; H04L 1/00; H04W 72/232

(52) U.S. Cl. CPC H04W 72/231; H04L 1/0061; H04W 72/232

(57) ABSTRACT

Various aspects of the present disclosure relate to rate split multiple access (RaSMA) schemes. For example, the present disclosure introduces a new type of identifier, such as a new RNTI, that is used during RaSMA from a transmitter to multiple receivers. The new RNTI, or similar identifiers, may be implemented in a variety of deployment scenarios, including one-layer RaSMA decoding at a receiver, two-layer hierarchical decoding at a receiver, assignment of a RNTI during initial access procedures, assignment of a RNTI during changes in UE or network conditions, and so on.

### TECHNICAL FIELD

The present disclosure relates to wireless communications, and more specifically to enhancing control messages for non-orthogonal multiple access (NOMA) schemes.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communication systems may support multiple access (MA), which may enable multiple user communication devices to simultaneous utilize a radio frequency spectrum. MA schemes include orthogonal MA (e.g., frequency division multiple access (FDMA), time division multiple access (TDMA)) and non-orthogonal MA (NOMA). NOMA may support wireless communications to multiple user communication devices within the same time-frequency resources using a power domain and/or a code domain.

An example of a NOMA technique includes rate split multiple access (RaSMA). According to RaSMA, a network communication device (e.g., a base station, network entity) may support splitting of messages, over non-orthogonally shared resources, into a common message stream transmitted to (and decoded by) each user communication device within a group of communication devices and private message streams transmitted to (and decoded by) specific user communication devices (e.g., devices for which the private messages are intended) within the group of devices. For example, a common message may comprise common components from messages transmitted to all user communication devices, and the private messages may comprise any remaining components not shared by all of the user communication devices. To retrieve a complete data message, a user communication device may decode the common message, including the corresponding private messages.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that facilitate the enhancement of control messages under RaSMA schemes.

Some implementations of the method and apparatuses described herein may further include a UE for wireless communication, comprising at least one memory, and at least one processor coupled with the at least one memory and configured to cause the UE to receive, from a network entity, a configuration message for RaSMA, wherein the configuration message comprises one or more initialization parameters, receive, from the network entity, a control message that comprises a scrambled cyclic redundancy check (CRC) sequence, descramble the scrambled CRC sequence using the one or more initialization parameters, and decode the control message using the descrambled CRC sequence.

In some implementations of the method and apparatuses described herein, the at least one processor is configured to cause the UE to decode the control message to obtain at least one common user data message and at least one private user data message.

In some implementations of the method and apparatuses described herein, the at least one processor is configured to cause the UE to decode the control message to obtain resource information for receiving the at least one common user data message and the at least one private user data message.

In some implementations of the method and apparatuses described herein, the one or more initialization parameters comprise a radio network temporary identifier (RNTI).

In some implementations of the method and apparatuses described herein, the one or more initialization parameters comprise a RNTI associated with at least one common user data message of the control message, and a second radio RNTI associated with at least one private user data message of the control message.

In some implementations of the method and apparatuses described herein, the first RNTI is associated with multiple UEs within a RaSMA group of UEs.

In some implementations of the method and apparatuses described herein, the at least one processor is configured to cause the UE to receive the configuration message for RaSMA during an initial access procedure.

In some implementations of the method and apparatuses described herein, the at least one processor is configured to cause the UE to receive the configuration message for RaSMA via radio resource control (RRC) signaling.

In some implementations of the method and apparatuses described herein, the at least one processor is configured to cause the UE to receive the configuration message for RaSMA via a physical downlink control channel (PDCCH) carrying a downlink control information (DCI) format associated with receiving and decoding NOMA data messages.

In some implementations of the method and apparatuses described herein, the control message is associated with dynamic scheduling of common user data messages and private user data messages.

In some implementations of the method and apparatuses described herein, the control message is associated with semi-persistent or periodic scheduling of common user data messages and private user data messages.

In some implementations of the method and apparatuses described herein, the control message comprises a set of CRC parity bits appended to a transport block associated with the control message.

Some implementations of the method and apparatuses described herein may further include a network entity for wireless communication, comprising at least one memory, and at least one processor coupled with the at least one memory and configured to cause the network entity to transmit, to a UE, a configuration message for RaSMA, wherein the configuration message comprises one or more initialization parameters, and transmit, to the UE, a control message that comprises a scrambled CRC sequence.

In some implementations of the method and apparatuses described herein, the one or more initialization parameters comprise an RNTI.

In some implementations of the method and apparatuses described herein, the one or more initialization parameters comprise a first RNTI associated with at least one common user data message of the control message and a second radio RNTI associated with at least one private user data message of the control message.

In some implementations of the method and apparatuses described herein, the first RNTI is associated with multiple UEs within a RaSMA group of UEs that includes the UE.

In some implementations of the method and apparatuses described herein, the at least one processor is further configured to cause the network entity to generate the scrambled CRC sequence using the one or more initialization parameters.

In some implementations of the method and apparatuses described herein, the at least one processor is configured to cause the network entity to transmit the RaSMA configuration message via RRC signaling.

Some implementations of the method and apparatuses described herein may further include a processor for wireless communication, comprising at least one controller coupled with at least one memory and configured to cause the processor to receive, from a network entity, a configuration message for RaSMA, wherein the configuration message comprises one or more initialization parameters, receive, from the network entity, a control message that comprises a scrambled CRC sequence, descramble the scrambled CRC sequence using the one or more initialization parameters, and decode the control message using the descrambled CRC sequence.

Some implementations of the method and apparatuses described herein may further include a UE, a configuration message for RaSMA, wherein the configuration message comprises one or more initialization parameters, and transmitting, to the UE, a control message that comprises a scrambled CRC sequence.

### BRIEF DESCRIPTION OF THE DRAWINGS

FIG. 1 illustrates an example of a wireless communications system in accordance with aspects of the present disclosure.

FIGS. 2A-2B illustrate example signaling between communication devices in accordance with aspects of the present disclosure.

FIG. 3 illustrates an example messaging flow between a transmitter and a receiver in accordance with aspects of the present disclosure.

FIG. 4 illustrates an example one-layer RaSMA scheme in accordance with aspects of the present disclosure.

FIG. 5 illustrates an example two-layer RaSMA scheme in accordance with aspects of the present disclosure.

FIGS. 6A-6B illustrate an example contention-based random access procedure in accordance with aspects of the present disclosure.

FIG. 7A illustrates an example reconfiguration message transfer in accordance with aspects of the present disclosure.

FIG. 7B illustrates an example connection re-establishment procedure in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of a network equipment (NE) in accordance with aspects of the present disclosure.

FIG. 11 illustrates a flowchart of a method performed by a UE in accordance with aspects of the present disclosure.

FIG. 12 illustrates a flowchart of a method performed by an NE in accordance with aspects of the present disclosure.

### DETAILED DESCRIPTION

Some wireless communications system, including network communication devices and user communication devices, may support RaSMA to enhance spectral efficiency and flexibility. However, these wireless communication systems, including network communication devices and user communication devices might be unable to support reliable (e.g., integrity) validation for a common message or private messages when the network communication devices (e.g., a base station) are configured to utilize RaSMA with multiple user communication devices (e.g., UEs). Put another way, these wireless communication systems currently are not deployed with a framework (e.g., functionality, configuration, mechanism) to support reliable validation for a common message or private messages.

Various aspects of the present disclosure enable network communication devices (e.g., base stations, network entities, transmitter entities, transmitter nodes) and user communication devices (e.g., UEs, receiver entities, receiver nodes) to support reliable (e.g., integrity) validation for a common message or private messages. Particularly, aspects of the present disclosure enable scheduling of a common transport block and/or private transport blocks for a group of user communication devices, while enabling the scheduling of a partial common message for a subset of the group of user communication devices. Additionally, aspects of the present disclosure support use of a new type of identifier, such as a new RNTI, which may be used between a network communication device (e.g., base station, network entity, transmitter entity, transmitter node) and multiple user communication devices (e.g., UEs, receiver entities, receiver nodes) when communicating (e.g., transmitting, receiving) control messages in accordance with an RaSMA scheme.

The new type of identifier (e.g., the new RNTI, a cell ID, and so on) may be implemented in various cases, including one-layer RaSMA decoding at the user communication devices (e.g., UEs, receiver entities, receiver nodes), two-layer hierarchical decoding at the user communication devices (e.g., UEs, receiver entities, receiver nodes), assignment of a RNTI during an initial access procedure, assignment of a RNTI during changes in conditions at one or more of the network communication devices (e.g., base stations, network entities, transmitter entities, transmitter nodes) and the user communication devices (e.g., UEs, receiver entities, receiver nodes), etc. Thus, the network communication devices (e.g., base stations, network entities, transmitter entities, transmitter nodes) and user communication devices (e.g., UEs, receiver entities, receiver nodes) to support reliable (e.g., integrity) may utilize RaSMA, and its advantages in spectral efficiency and flexibility, while reducing (e.g., minimizing) issues associated with messaging between the communication devices, among other benefits.

Aspects of the present disclosure are described in the context of a wireless communications system.

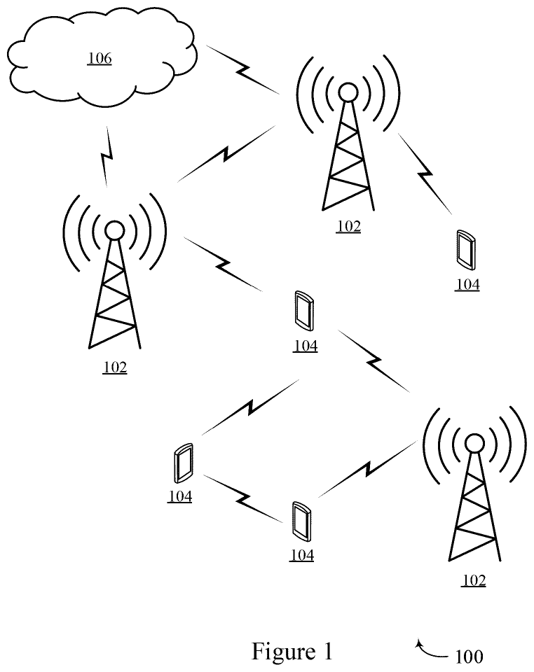

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHz-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities. In some implementations, FR3 may be used by the NEs 102 and the UEs 104, among other equipment or devices for cellular communications traffic (e.g., control information, data, and so on).

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the systems and methods may support hybrid multiple access schemes, such as RaSMA. RaSMA leverages the rate splitting (RS) of messages, such as transport blocks, and linear precoding in multi-antenna systems for multiple user communication devices within network communications systems.

RaSMA splits (and later re-combines) multiple user messages to form a common message, with remaining portions of the user messages forming private messages that are specific to each user. For example, the common message may be a message composed of a portion of K user messages, and the private messages may be a message composed on remaining portions of the K user messages.

The combined common message is encoded into one or more common streams and the private messages are separately encoded into private streams. The streams are precoded utilizing available channel state information at the transmitter (CSIT), whether it's perfect or imperfect. The streams are superimposed and transmitted using either multiple-input multiple-output (MIMO) or multiple-input single-output (MISO) broadcast channels (BC).

During reception of the streams, the receiving devices (e.g., a group of UEs) decode the common stream (or streams) and may apply successive interference cancellation (SIC) techniques to subtract the decoded common message stream from each of the devices received signals and then subsequently decode the respective private streams. Each UE deconstructs its original message by combining the portion embedded in the common streams with its specific private stream.

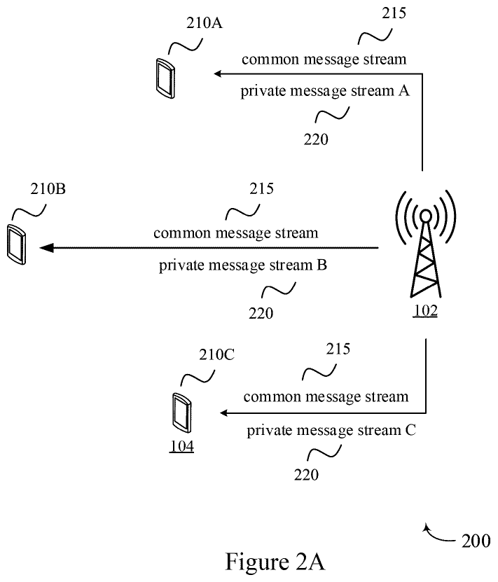

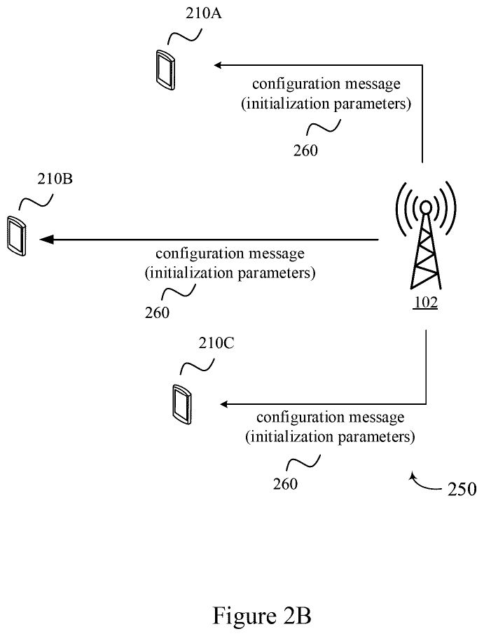

FIG. 2A illustrates example signaling 200 between communication devices in accordance with aspects of the present disclosure. The NE 102 transmits messages to a group of UEs 210A-C under a RaSMA scheme. For example, the NE 102 transmits a common message stream 215, as described herein, to all of the UEs 210A-C, and a private message stream 220 separately to each of the UEs 210A-C. Thus, UE 210A receives the common message stream 215 and a private message stream A, the UE 210B receives the common message stream 215 and a private message stream B, and the UE 210C receives the common message stream 215 and a private message stream C.

An example implementation is as follows: many users (e.g., users associated with the UEs 210A-C) are streaming a live event (e.g., a football match). The NE 102 transmits a video stream of the live event to all the users via a common message stream, and specific betting information to each of the users via a private message stream specific to the users.

As described herein, in some embodiments, the NE 102 utilizes a RNTI or other initialization parameters (e.g., cell ID) when sending control messages to the UEs 210A-C.

FIG. 2B illustrates example signaling 250 between communication devices in accordance with aspects of the present disclosure. In accordance with a RaSMA scheme, the NE 102 sends, transmits, and/or transfers a configuration message 260 that includes initialization parameters (e.g., a RNTI, such as a rate split RNTI, or RS-RNTI). The UEs 210A-C may utilize the initialization parameters to scramble and/or de-scramble RaSMA control message information, such as information contained in common messages, private user messages, and so on.

In some embodiments, a transmitter, such as a cell or base station (e.g., the NE 102), generates a common message and private messages for K users (e.g., a number of UEs for a given cell or the number of UEs in a cell-free scenario, such as the UEs 210A-C). To identify and address the UEs (e.g., the UEs 210A-CO, the transmitter (e.g., the NE 102) employs a new or specified initialization parameter (e.g., a new RNTI). As described herein, the RNTI may be referred to as an RS-RNTI, a rate split configured scheduling RNTI (RS-CS-RNTI), among other names or designations.

The transmitter (e.g., the NE 102) may signal the RNTI and/or other initialization parameters via various mechanisms or scenarios, including during an initial access procedure or setup, during an ongoing communication session (e.g., when receiving downlink control or data in an RRC_CONNECTED state), during reconfiguration of a UE (e.g., the UEs 210A-C) based on link conditions, such as UE mobility, re-connection establishment, radio link failures, and so on.

In some embodiments, the transmitter (e.g., the NE 102) may generate a scrambling sequence using or based on the RNTI or other initialization parameters. The transmitter may employ the scrambling sequence to scramble an n-bit CRC, where n (e.g., n=24) denotes the number of CRC bits. The transmitter may generate/employ various scrambling sequences, including:

A linear feedback shift register (LFSR)-a linear function where the input is a linear function of a previous state (e.g., an XOR function that scrambles a set of bits, such as the CRC bits);

A gold sequences—type of binary sequence where the output gold codes have small cross correlations effects (e.g., such as when there are two or more UEs). For example, during operation of a gold sequence, two maximum length sequences of the same length 2ⁿ−1 are selected such that their absolute cross-correlation is less than 2^{(n+2)/2}, where n is the size of the LFSR used to generate the gold sequence. To initialize the sequence, the RNTI may be used in addition to the number of symbols per slot;

A Kasami sequences-a binary sequence of length 2^{P}−1, where P is an even integer number with good cross-correlation values. In operation, a maximum primary sequence a(n) is considered when a secondary sequence is generated using the primary sequence and based on a cyclic decimation operation as follows: b(n)=a(q·n), where

$$q = {2}^{\frac{P}{2}} + 1 ,$$

thereafter the Kasami sequence is generated as follows: a(n) XOR b(n shifted). In operation, the RNTI may be used to generate the primary sequence;

JPL sequences—two LFSRs, with code sequence lengths, Lₐ and L_{b}, that are prime, where the JPL sequence is L_{c}=Lₐ·L_{b}=(2ⁿ−1)(2^{m}−1). In operation, the RNTI may be used to generate the LFSR sequence that is used to generate the JPL sequence;

Other pseudorandom binary sequence generators having useful correlation properties (e.g., including auto-correlation and cross-correlation); and so on.

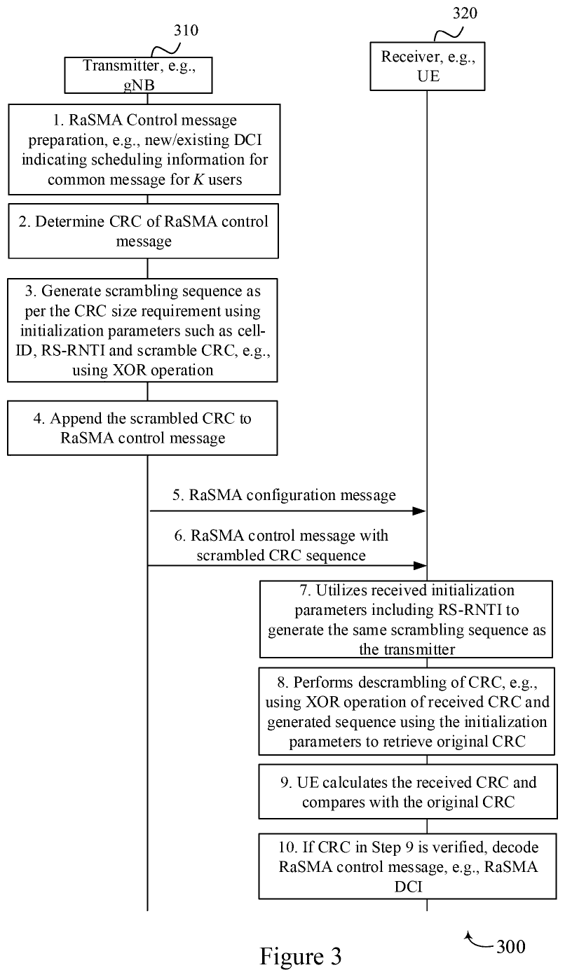

FIG. 3 illustrates an example messaging flow 300 between a transmitter and a receiver in accordance with aspects of the present disclosure. The messaging flow 300 may implement various aspects of the present disclosure described herein. For example, the messaging flow 300 may include a transmitter (e.g., a base station) 310 and a receiver (e.g., a UE) 320, which may be examples of NEs and UEs, as described herein. In the following description of the messaging flow 300, the operations between the transmitter 310 and the receiver 320 may be performed in different orders or at different times. Some operations may also be omitted, or other operations may be added. Although the transmitter 310 and the receiver 320 are shown performing the operations of the messaging flow 300, some aspects of some operations may also be performed by other entities of the messaging flow 300 or by entities that are not shown in the messaging flow 300, or any combination thereof.

The messaging flow depicts an overall process for utilizing an RNTI to provide reliable and valid control information between devices during RaSMA messaging (e.g., the transfer, reception, and decoding of common messages and private messages).

In step 1, the transmitter 310 prepares control information, which is to be utilized to convey control messages and related information used to support decoding of RaSMA user data messages for K users. The control information may include scheduling information (e.g., frequency domain and time domain assignments of a common message and private messages for K users). The transmitter 310 may prepare the control information as a DCI, such as via a newly defined DCI format type and/or by re-using legacy DCI formats (e.g., DCI Formats 0_0, 0_1, 1_0, 1_1 and so on).

In step 2, the transmitter 310 determines a CRC of the control message. The CRC may represent a set of parity bits that are appended to a main set of bits associated with the actual control message. The transmitter 310 may utilize one or more selected cyclic generator polynomials, based on a desired size of the CRC, such as the following:
For n=24-bit, type-A, CRC g_{CRC24A}(D)=D²⁴+D²³+D¹⁸+D¹⁷+D¹⁴+D¹¹+D¹⁰+D⁷+D⁶+D⁵+D⁴+D³+D+1;
For n=24-bit, type-B, CRC g_{CRC24B}(D)=D²⁴+D²³+D⁶+D⁵+D+1;
For n=24-bit, type-C, CRC g_{CRC24C}(D)=D²⁴+D²³+D²¹+D²⁰+D¹⁷+D¹⁵+D¹³+D¹²+D⁸+D⁴+D²+D+1;
For n=16-bit, CRC g_{CRC16}(D)=D¹⁶+D¹²+D⁵+1;
For n=11-bit, CRC g_{CRC11}(D)=D¹¹+D¹⁰+D⁹+D⁵+1;
For n=6-bit, CRC g_{CRC6}(D)=D⁶+D⁵⁺¹; and/or
any other n-Bit CRC with associated cyclic generator polynomial.

In step 3, the transmitter 310 generates a scrambling sequence using initialization parameters, such as an RNTI (e.g., the RS-RNTI/RS-CS-RNTI), a cell-ID, a number of symbols per slot, and so on. The transmitter 310 scrambles the CRC using a scrambling sequence, as described herein (e.g., applies an XOR operation with the generated CRC to yield a scrambled sequence).

In step 4, the transmitter 310 appends or otherwise attaches the scrambled CRC to a control message payload (e.g., a RaSMA DCI message).

In step 5, the transmitter 310 transmits control configuration information to the UE 320 (e.g., one of multiple UEs). The control configuration information may include the initialization parameters used to scramble a message transmitted from the transmitter 310, such as the RS-RNTI.

In step 6, the transmitter 310 transmits the control message payload with the scrambled CRC to the UE 320.

In step 7, the UE 320 receives the initialization parameters (e.g., the RS-RNTI, cell ID, and so on) and generates the scrambling sequence.

In step 8, the UE 320 performs a blind search for the control message, including the descrambling of the CRC (e.g., using an XOR operation of the received CRC and generated sequence using the initialization parameters to retrieve an original CRC generated at the transmitter 310).

In step 9, the UE 320 determines or otherwise calculates the received CRC based on the received data and compares this received CRC with the descrambled CRC (e.g., the CRC based on CRC bits originally transmitted).

In step 10, upon matching the CRCs during the comparison (e.g., verifying the received CRC as the original CRC), the UE 320 decodes the RaSMA control message (e.g., the RaSMA DCI) and retrieves scheduling information of the common message streams and private message streams. In some cases, upon failing to verify the received CRC, the UE 320 may continue its blind search for other candidates and other aggregation levels using the same RS-RNTI.

In some cases, the UE 320 utilizes a single RNTI or other parameter when decoding the RaSMA control message to obtain scheduling information for both common and private messages. However, in some cases, the UE 320 may utilize multiple RNTIs, assigned by the transmitter 310, for the decoding of control messages.

For example, a first RNTI (e.g., an RSC-RNTI) may be used to scramble the RaSMA control message containing scheduling information for the common message, which is transmitted to all K users in a group of users. In some cases, the RSC-RNTI may be specific to a specific group of K users that share a specific common message applicable to the specific group of K users. K may be the same number or a different number of users, depending on various factors associated with each group of K users (e.g., K users that share the same channel conditions may be grouped).

A second RNTI (e.g., an RSP-RNTI) may be used to scramble the RaSMA control message containing scheduling information for the private messages for each of the users of the group of K users. Thus, the transmitter 310 may transmit an RSC-RNTI (used to decode the group common RaSMA control message) via a first DCI format and transmit an RSP-RNTI (used to decode the user private messages) via a second, separate, another DCI format. Use of two RNTIs and two associated DCI formats may preserve the privacy and integrity of the control messages associated with the group common RaSMA control message and the RaSMA private user messages.

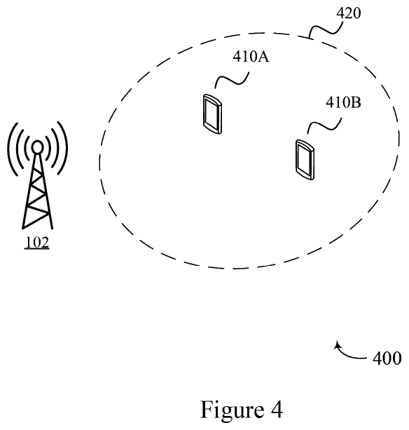

FIG. 4 illustrates an example one-layer RaSMA scheme 400 in accordance with aspects of the present disclosure. A cell (e.g., the NE 102) includes two UEs 410A and 410B. The NE 102 utilizes a RaSMA DCI format X and transmits a group common message 420 to the UEs 410A and 410B (while using a different format, DCI Y-1 and Y-2, for transmitting control for decoding private messages by the UEs 410A and 410B).

In some cases, the DCI format is based on or corresponds to a type of control information for a certain set of users, regardless of the number of users (e.g., a DCI format for a group common message, and another DCI format for the private messages for each user). Further, in some cases, the initialization parameters may be associated, such that an RSC-RNTI may correspond to, or be associated with, an RSP-RNTI.

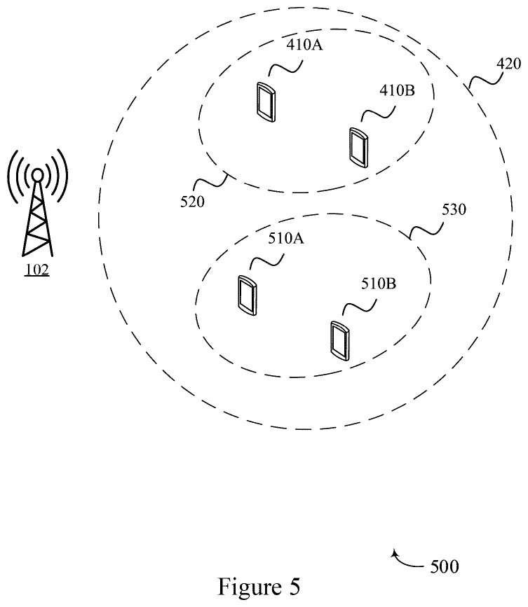

In some embodiments, the transmitter may define the RaSMA RNTI for two-layer (2-layer) hierarchical rate split multiple access. FIG. 5 illustrates an example two-layer RaSMA scheme 500 in accordance with aspects of the present disclosure. As depicted, four UEs (e.g., K=4 users) are divided into M=2 non-overlapping groups of users (e.g., a first group of UEs 410A and 410B and a second group of UEs 510A and 510B), based on certain conditions.

The transmitter may create groups of UEs based on a variety of factors, including:
The co-location of UEs in the same geographical region (e.g., sharing the same PCI or located close to each other (e.g., within a few meters));
UEs served by the same Tx spatial beam;
UEs that display similar link/channel characteristics (e.g., reference signal (RS) reference signal received power (RSRP)/reference signal reception quality (RSRQ)/received signal strength indicator (RSSI) metrics, similar channel coefficients, similar link budgets, and so on;
UEs having similar capabilities (UEs from a similar category or type); and so on.

In some cases, data streams of a high stream order are decoded before data streams of a lower stream order, and thus user ordering for successive interference cancellation (SIC) decoding may not be utilized. Therefore, SIC decoding ordering at a receiver may be performed, as follows:

The group common message 420, comprising a portion of messages from UEs 410A, 410B, 510A, 510B, is first decoded, treating the remaining received signals as noise (e.g., colored noise due to the presence of multi-user interference).

Next, the UE 410A decodes a group 1 partial common message 520, comprising a portion of messages from the UE 410A and UE 410B by applying SIC of the decoded group common message 420, while treating the remaining received signals as noise.

Then, the UE 410A decodes its own private message stream by applying SIC to the already decoded group 1 partial common message 520. The other UEs may performed similar steps (e.g., the UE 510B may decode the group common message 520 and then the a group 2 partial common message 530).

In some cases, the group common message 420 may be generated using an RNTI and assigned to the UEs 410A, 410B, 510A, 510B, which decode RaSMA control messages that contain scheduling information about the group common message 420. The group common message 420 may be transmitted on a PDSCH or common channel (e.g., via broadcast (PBCH) or multicast channel (MCH), for receiving the common message).

In some cases, because there are two layers of common message decoding, the devices may employ an additional RNTI, such as a common partial RaSMA RNTI, for decoding the partial group common messages 520, 530. For example, while the group common partial RaSMA control message and the group common RaSMA control message may share the same DCI (and thus use one RaSMA RNTI) different groups of UEs may be able to decode all the group partial common specific information.

Thus, the group common partial RaSMA control message and the group common RaSMA control message may be transferred via separate DCI formats, in order to preserve the privacy and integrity of the control messages associated with the group common partial RaSMA control message (e.g., for the subset of the overall group) and group common RaSMA control messages.

For example, a RaSMA DCI format X may be applicable to the group common message for all UEs. However, a RaSMA DCI format Y-1 may be applicable to the group common message for a subset of UEs (e.g., the UEs 410A and 410B), while another RaSMA DCI format Y-2 may be applicable to the group common message for another subset of UEs (e.g., the UEs 510A and 510B). Further, DCI Formats Z-1, Z-2, Z-3, Z-4 are then used by each UE for decoding its private message stream.

In some embodiments, a UE is assigned an RS-RNTI during an initial access procedure. For example, the initial access procedure may include an contention-based or contention-free initial access procedure, with the RS-RNTI (or another parameter) allocated or provided to the UE during the establishment of the procedure.

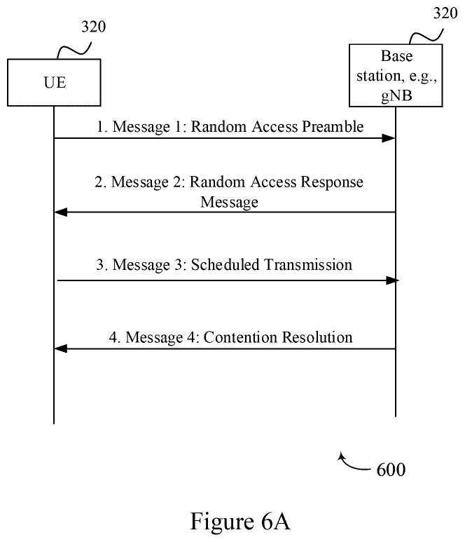

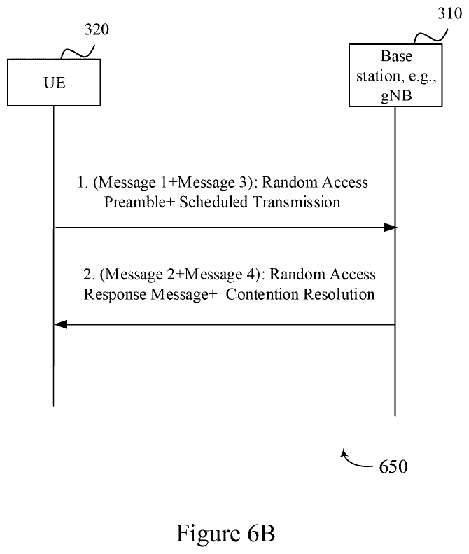

FIGS. 6A-6B illustrate an example contention-based random access procedure in accordance with aspects of the present disclosure. As depicted, FIG. 6A depicts a four-step procedure 600, and FIG. 6B depicts a two-step procedure 650.

In step 1 (message 1) of FIG. 6A, the UE 320 selects a preamble from a set of preambles generated as part of a physical random access channel (PRACH) configuration transmitted by a base station (e.g., a gNB) in the form of system information block messages, SIB1, as part of a prior step and transmits the message 1 (Random Access Preamble) on the PRACH channel.

An RNTI (e.g., a RA-RNTI) is determined based on a pre-determined formula. The RNTI may be determined by the UE 320, the transmitter 310, and/or assigned by another base station or gNB during the initial access procedure. For example, the UE 320 may compute its own unique RS-RNTI for supporting RaSMA multiple access (applicable to both the common and private messages) based on a pre-determined formula that is a function of the symbol number, slot index, PRACH, or any other reference signal occasion index and UL transmission signal information (e.g., UL carrier indication, NUL or SUL carrier, and so on).

As another example, the UE 320 may compute a separate RA-RNTI for non-orthogonal multiple access, such as for receiving scheduled data transmissions in a non-orthogonal manner. The new RA-RNTI may be computed, as described herein.

As another example, the UE 320 may compute its own RSC-RNTI and RSP-RNTI for supporting the common and private message reception based on a pre-determined formula that is also a function of the symbol number, slot index, PRACH or any other signal occasion index and UL transmission signal information (e.g., UL carrier indication, NUL or SUL carrier).

In step 2 (message 2), the transmitter 310, such as the gNB, determines the same RNRI (e.g., a RA-RNTI, a new RS-RNTI, a new RA-RNTI for non-orthogonal multiple access, an RSC-RNTI, an RSP-RNTI using the same formula used by the UE 320) and scrambles the CRC of a RaSMA control message and transmits the scrambled CRC to the UE 320 using downlink signaling (e.g., control signaling using the PDCCH, DCI signaling, DL MAC CE signaling, and so on). The downlink signaling may contain the uplink grant for transmitting the message 3.

The UE 320 may then monitor a region for receiving and decoding the downlink signaling (e.g., the control region, a configured CORESET, control time-frequency resources, based on a predefined region/duration, e.g., using a time window configuration provided to the UE 320 in an apriori manner using a system information block message or UE-specific messages). The time window configuration details may include start time, window length/duration, end time, periodicity (if applicable), window ID and other related configuration details.

The UE 320 initiates monitoring of the time-frequency region according to the window configuration details system information block message or UE-specific messages. Once the UE 320 successfully decodes the PDCCH with a CRC scrambled having an RNTI, the UE 320 decodes the PDSCH carrying random access response (RAR) data. In some cases, such when the RNTI is not provided in a previous step, the RAR data may comprise a new RS-RNTI, RSC-RNTI, or RSP-RNTI used to decode non-orthogonally scheduled data in addition to the TA command, UL grant and so on. In some cases, the RNTI may be temporarily assigned and re-assigned after initial access and during an ongoing connection.

In step 3 (message 3), the UE 320 utilizes the UL grant provided in message 2 to send message 3 on PUSCH. The message 3 is sent on PUSCH along with an RRC message (e.g., an RRC setup request carrying IEs: UE Identity & Establishment cause). The UE 320 may transmit message 3 after n slots of having received message 2 (e.g., PDSCH containing the random access response message), from the transmitter 310, in order to ensure a minimum time period between reception of message 2 and transmission of message 3.

In step 4 (message 4), the transmitter 310 transmits the message 4 to the UE 320 to enable contention resolution. The transmitter (e.g., gNB) transmits a further control message (e.g., DCI) that includes the CRC scrambled with RS-RNTI or RSC-RNTI/RSP-RNTI, scheduling a PDSCH in a non-orthogonal manner that includes a UE contention resolution identity.

In some cases, the two-step procedure 650 of FIG. 6B reduces the number of steps of the initial access procedure by combining message 1 and message 3 into a new message A and combining message 2 and message 4 into a new message B. The RNTI determination or assignment, as described herein, is similarly applicable to message A and/or message b of the two-step procedure 650.

In some cases, an RNTI is based on a type of configured non-orthogonal multiple access scheme, where the UEs employ the same resources in time, frequency, and space. Other NOMA schemes may include power domain NOMA, SCMA, resource spread multiple access, and so on.

In some embodiments, an RS-RNTI, or similar rate-split multiple access RNTI, may be allocated and/or assigned to the UE 320 during re-configuration signaling based on certain radio event or channel condition changes. In some cases, an RRC re-configuration message is utilized to signal re-configuration information to the UE 320 in the event that a re-configuration is required or during an interruption of communication (e.g., a radio link failure, a mobility event such as a handover, and so on).

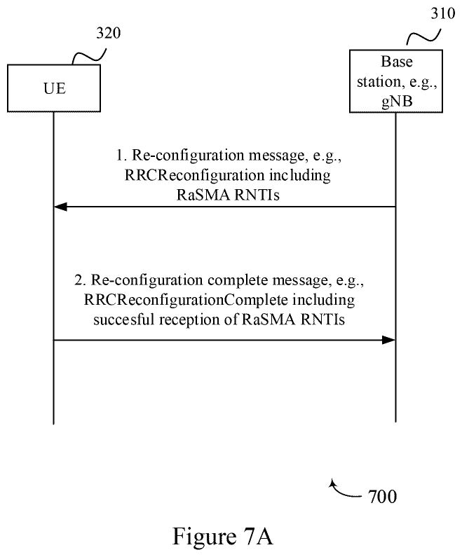

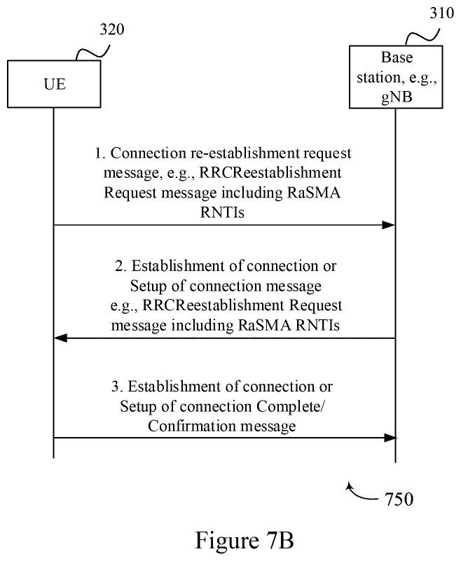

FIG. 7A illustrates an example reconfiguration message transfer 700 in accordance with aspects of the present disclosure. In step 1, the transmitter 310 (e.g., a base station, such as a gNB) transmits a re-configuration message to the UE 320 that comprises an RNTI for RaSMA (e.g., one or more RNTIs for common messages and/or private messages. In step 2, the UE 320 confirms the reception of the RaSMA RNTI by sending a confirmation message to the transmitter 310.

In some embodiments, the UE 320 shares a previous or current RaSMA RNTI with the transmitter 310, such as a base station, during a re-establishment request or connection setup with the network. FIG. 7B illustrates an example connection re-establishment procedure 750 in accordance with aspects of the present disclosure.

In step 1, the UE 320 requests a connection re-establishment with the network, such as with the transmitter 310 (e.g., a base station). The UE 320 may indicate its own RS-RNTI or RSC-RNTI or RSP-RNTI prior to the change in UE/network conditions (e.g., during radio link failure (RLF)).

In step 2, the transmitter 310 confirms establishment of the requested connection by either maintaining the RS-RNTI or RSC-RNTI or RSP-RNTI originally assigned to the UE 320 or by re-allocating new RaSMA RNTIs, as described herein. For example, a new RaSMA RNTI may be allocated when the UE 320 is connected to another base station, such as during or after a handover. In some cases, the network (e.g., the transmitter 31) may set up a new connection using an RRC setup message. The network may provide an indication via a flag or another type of indication (e.g., without having to re-signal the same RNTIs) when maintaining the same RNTIs.

In step 3, the UE 320 confirms the connection re-establishment or the new connection with the network based on the received RNTIs, which assist in decoding RaSMA downlink control information, as described herein.

Thus, as described herein, the establishment and deployment of RaSMA specific RNTIs may enable the secure communication and integrity of messages transmitted between a transmitter (e.g., a base station or other NE) and UEs performing rate split multiple access or related non-orthogonal multiple access procedures, among other benefits.

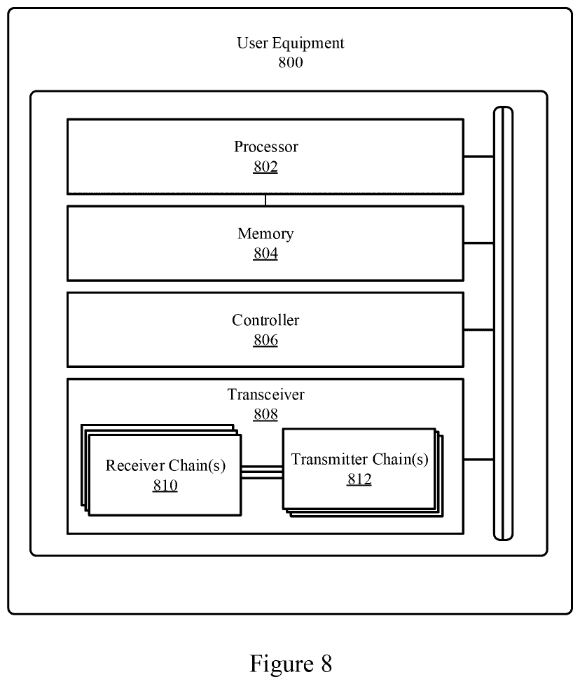

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to support a means for receiving, from a network entity, a configuration message for rate RaSMA, wherein the configuration message comprises one or more initialization parameters, receiving, from the network entity, a control message that comprises a scrambled CRC sequence, descrambling the scrambled CRC sequence using the one or more initialization parameters, and decoding the control message using the descrambled CRC sequence.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

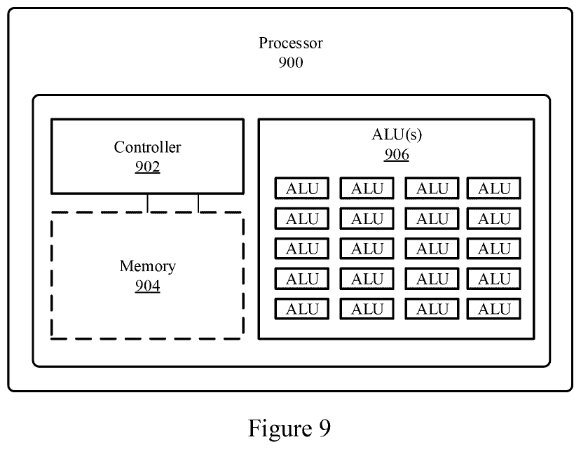

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The UE processor 900 may be configured to support a means for receiving, from a network entity, a configuration message for rate RaSMA, wherein the configuration message comprises one or more initialization parameters, receiving, from the network entity, a control message that comprises a scrambled CRC sequence, descrambling the scrambled CRC sequence using the one or more initialization parameters, and decoding the control message using the descrambled CRC sequence.

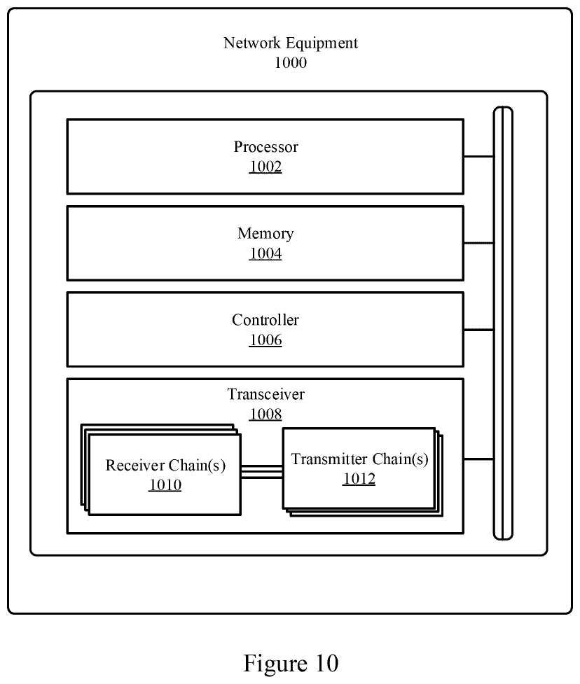

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to support a means for transmitting, to a UE, a configuration message for RaSMA, wherein the configuration message comprises one or more initialization parameters, and transmitting, to the UE, a control message that comprises a scrambled CRC sequence.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receive the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

As described herein, various implementations may include the UE 800 as a Tx node or Rx node, the processor 900 as the Tx node or Rx node, and/or the NE 1000 as the Tx node or Rx node.

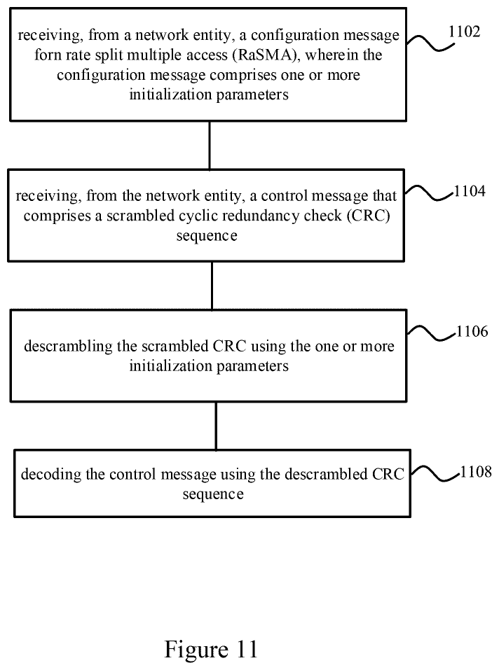

FIG. 11 illustrates a flowchart of a method in accordance with aspects of the present disclosure. The operations of the method may be implemented by a UE as described herein. In some implementations, the UE may execute a set of instructions to control the function elements of the UE to perform the described functions.

At 1102, the method may include receiving, from a network entity, a configuration message for rate RaSMA, wherein the configuration message comprises one or more initialization parameters. The operations of 1102 may be performed in accordance with examples as described herein. In some implementations, aspects of the operations of 1102 may be performed by a UE as described with reference to FIG. 8.

At 1104, the method may include receiving, from the network entity, a control message that comprises a scrambled CRC sequence. The operations of 1104 may be performed in accordance with examples as described herein. In some implementations, aspects of the operations of 1104 may be performed by a UE as described with reference to FIG. 8.

At 1106, the method may include descrambling the scrambled CRC sequence using the one or more initialization parameters. The operations of 1106 may be performed in accordance with examples as described herein. In some implementations, aspects of the operations of 1106 may be performed by a UE as described with reference to FIG. 8.

At 1108, the method may include and decoding the control message using the descrambled CRC sequence. The operations of 1108 may be performed in accordance with examples as described herein. In some implementations, aspects of the operations of 1108 may be performed by a UE as described with reference to FIG. 8.

It should be noted that the method described herein describes a possible implementation, and that the operations and the steps may be rearranged or otherwise modified and that other implementations are possible.

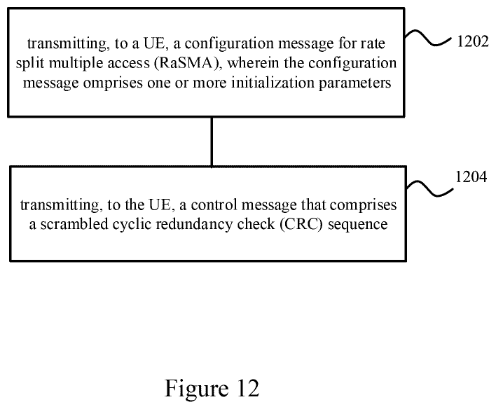

FIG. 12 illustrates a flowchart of a method in accordance with aspects of the present disclosure. The operations of the method may be implemented by an NE as described herein. In some implementations, the NE may execute a set of instructions to control the function elements of the NE to perform the described functions.

At 1202, the method may include for transmitting, to a UE, a configuration message for RaSMA, wherein the configuration message comprises one or more initialization parameters. The operations of 1202 may be performed in accordance with examples as described herein. In some implementations, aspects of the operations of 1202 may be performed by an NE as described with reference to FIG. 10.

At 1204, the method may include and transmitting, to the UE, a control message that comprises a scrambled CRC sequence. The operations of 1204 may be performed in accordance with examples as described herein. In some implementations, aspects of the operations of 1204 may be performed by an NE as described with reference to FIG. 10.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a network entity, a configuration message for rate split multiple access (RaSMA), wherein the configuration message comprises one or more initialization parameters;
receive, from the network entity, a control message that comprises a scrambled cyclic redundancy check (CRC) sequence;
descramble the scrambled CRC sequence using the one or more initialization parameters; and
decode the control message using the descrambled CRC sequence.

2. The UE of claim 1, wherein the at least one processor is configured to cause the UE to decode the control message to obtain at least one common user data message and at least one private user data message.

3. The UE of claim 2, wherein the at least one processor is configured to cause the UE to decode the control message to obtain resource information for receiving the at least one common user data message and the at least one private user data message.

4. The UE of claim 1, wherein the one or more initialization parameters comprise a radio network temporary identifier (RNTI).

5. The UE of claim 1, wherein the one or more initialization parameters comprise:
a first radio network temporary identifier (RNTI) associated with at least one common user data message of the control message; and
a second radio RNTI associated with at least one private user data message of the control message.

6. The UE of claim 5, wherein the first RNTI is associated with multiple UEs within a RaSMA group of UEs.

7. The UE of claim 1, wherein the at least one processor is configured to cause the UE to receive the configuration message for RaSMA during an initial access procedure.

8. The UE of claim 1, wherein the at least one processor is configured to cause the UE to receive the configuration message for RaSMA via radio resource control (RRC) signaling.

9. The UE of claim 1, wherein the at least one processor is configured to cause the UE to receive the configuration message for RaSMA via a physical downlink control channel (PDCCH) carrying a downlink control information (DCI) format associated with receiving and decoding non-orthogonal multiple access (NOMA) user data messages.

10. The UE of claim 1, wherein the control message is associated with dynamic scheduling of common user data messages and private user data messages.

11. The UE of claim 1, wherein the control message is associated with semi-persistent or periodic scheduling of common user data messages and private user data messages.

12. The UE of claim 1, wherein the control message comprises a set of CRC parity bits appended to a transport block associated with the control message.

13. A network entity for wireless communication, comprising:
at least one memory; and
at least one processor coupled with the at least one memory and configured to cause the network entity to:
transmit, to a user equipment (UE), a configuration message for rate split multiple access (RaSMA), wherein the configuration message comprises one or more initialization parameters; and
transmit, to the UE, a control message that comprises a scrambled cyclic redundancy check (CRC) sequence.

14. The network entity of claim 13, wherein the one or more initialization parameters comprise a radio network temporary identifier (RNTI).

15. The network entity of claim 13, wherein the one or more initialization parameters comprise:
a first radio network temporary identifier (RNTI) associated with at least one common user data message of the control message; and
a second radio RNTI associated with at least one private user data message of the control message.

16. The network entity of claim 15, wherein the first RNTI is associated with multiple UEs within a RaSMA group of UEs that includes the UE.

17. The network entity of claim 13, wherein the at least one processor is further configured to cause the network entity to:
generate the scrambled CRC sequence using the one or more initialization parameters.

18. The network entity of claim 13, wherein the at least one processor is configured to cause the network entity to transmit the RaSMA configuration message via radio resource control (RRC) signaling.

19. A processor for wireless communication, comprising:
at least one controller coupled with at least one memory and configured to cause the processor to:
receive, from a network entity, a configuration message for rate split multiple access (RaSMA), wherein the configuration message comprises one or more initialization parameters;
receive, from the network entity, a control message that comprises a scrambled cyclic redundancy check (CRC) sequence;
descramble the scrambled CRC sequence using the one or more initialization parameters; and
decode the control message using the descrambled CRC sequence.

20. A method performed by a network entity, the method comprising:
transmitting, to a user equipment (UE), a configuration message for rate split multiple access (RaSMA), wherein the configuration message comprises one or more initialization parameters; and
transmitting, to the UE, a control message that comprises a scrambled cyclic redundancy check (CRC) sequence.
